(19) United States
(12) Patent Application Publication
(10) Pub. No.: US 2012/0249994 A1
(43) Pub. Date: Oct. 4, 2012

(54) LITHOGRAPHIC APPARATUS AND A DEVICE MANUFACTURING METHOD

(75) Inventors: Emilius Willem Adriaan VISSER, Eindhoven (NL); Alexander Nikolov ZDRAVKOV, Eindhoven (NL); Nina Vladimirovna DZIOMKINA, Eindhoven (NL)

(73) Assignee: ASML NETHERLANDS B.V., Veldhoven (NL)

(21) Appl. No.: 13/369,060

(22) Filed: Feb. 8, 2012

Related U.S. Application Data
(60) Provisional application No. 61/468,355, filed on Mar. 28, 2011.

(51) Int. Cl. G03B 27/52

(52) U.S. Cl. 355/77; 355/18

(57) ABSTRACT

An immersion lithographic apparatus includes a surface having at least one active group (e.g., lyophobic group) which, during use, comes into contact with immersion liquid, and an immersion liquid supply system configured to provide immersion liquid comprising a protection component which is more reactive with a product of photoionization of the immersion liquid than the active group of the surface, the protection component being present in an amount of between 1 ppm and 0.1 ppm.

This application claims priority and benefit under 35 U.S.C. §119(e) to U.S. Provisional Patent Application No. 61/468,355, entitled “A Lithographic Apparatus and A Device Manufacturing Method”, filed on Mar. 28, 2011. The content of that application is incorporated herein in its entirety by reference.

### FIELD

The present invention relates to a lithographic apparatus and a method for manufacturing a device using a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, device structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

### SUMMARY

Various parts in a lithographic apparatus may comprise a surface (with, e.g., a coating), for instance to protect the parts or to provide the parts with certain functionality, e.g. lyophobicity or lyophilicity. Functionality may, however, decrease over time.

It is desirable, for example, to provide a lithographic apparatus in which the likelihood or rate of deterioration of lyophobicity and/or lyophilicity is reduced.

According to an aspect, there is provided an immersion lithographic apparatus comprising: a lyophobic surface comprising at least one lyophobic group which, during use, comes into contact with immersion liquid; and an immersion liquid supply system configured to provide immersion liquid comprising a protection component which is more reactive with a product of photoionization of the immersion liquid than at least one lyophobic group of the lyophobic surface, the protection component being present in an amount of at least 0.1 ppm.

According to an aspect, there is provided an immersion lithographic apparatus comprising: a lyophilic surface comprising at least one lyophilic group which, during use, comes into contact with immersion liquid; and an immersion liquid supply system configured to provide immersion liquid comprising a protection component which is more reactive with a product of photoionization of the immersion liquid than at least one lyophilic group of the lyophilic surface, the protection component being present in an amount of at least 0.1 ppm.

According to an aspect, there is provided an immersion lithographic apparatus comprising: an active surface comprising at least one active group which, during use, comes into contact with immersion liquid, the surface having or exceeding a certain contact angle with respect to the immersion liquid; and an immersion liquid supply system configured to provide immersion liquid comprising a protection component which is more reactive with a product of photoionization of the immersion liquid than at least one active group of the surface, the protection component being present in an amount of at least 0.1 ppm.

According to an aspect, there is provided a device manufacturing method comprising providing a liquid on a lyophobic surface comprising at least one lyophobic group, wherein the liquid comprises a protective component which is more reactive with a product of photoionization of the immersion liquid than at least one lyophobic group of the lyophobic surface, the protection component being present in an amount of at least 0.1 ppm.

According to an aspect, there is provided an immersion lithographic apparatus comprising: a lyophobic surface comprising at least one lyophobic group which, during use, comes into contact with immersion liquid; and an immersion liquid supply system configured to provide immersion liquid comprising a protection component which is more reactive with a product of photoionization of the immersion liquid than at least one lyophobic group of the lyophobic surface, the protection component being an antioxidant.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts a further liquid supply system for use in a lithographic projection apparatus;

FIG. 6 illustrates the structure of DLN-F;

FIG. 7 depicts, in cross-section, a principle for addition of a protection component into immersion liquid;

FIG. 8 depicts, in cross-section, an embodiment for addition of a protection component into immersion liquid;

FIG. 9 is a graph of receding contact angle on the y-axis versus radiation dose on the x-axis for Lipocer™ under deep ultraviolet (DUV) irradiation and with water flowing over the Lipocer™ with three different oxygen concentrations; and

FIG. 10 is a graph of receding contact angle on the y-axis versus radiation dose on the x-axis for DLN-F under DUV irradiation and with water flowing over the DLN-F with three different oxygen concentrations.

### DETAILED DESCRIPTION

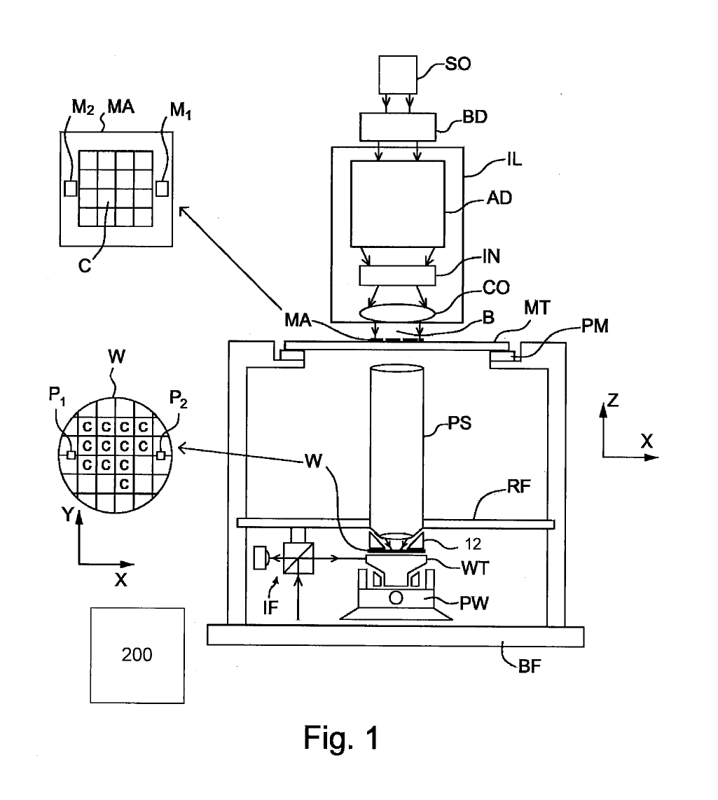

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device MA in accordance with certain parameters;

a support table, e.g. a sensor table to support one or more sensors or a substrate table WT constructed to hold a substrate (e.g. a resist-coated substrate) W, connected to a second positioner PW configured to accurately position the surface of the table, for example of a substrate W, in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA. It holds the patterning device MA in a manner that depends on the orientation of the patterning device MA, the design of the lithographic apparatus, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device MA may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two or more tables (or stage or support), e.g., two or more substrate tables or a combination of one or more substrate tables and one or more sensor or measurement tables. In such “multiple stage” machines the multiple tables may be used in parallel, or preparatory steps may be carried out on one or more tables while one or more other tables are being used for exposure. The lithographic apparatus may have two or more patterning device tables (or stages or support) which may be used in parallel in a similar manner to substrate, sensor and measurement tables.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as a-outer and a-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions C (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam B is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Arrangements for providing liquid between a final element of the projection system PS and the substrate can be classed into three general categories. These are the bath type arrangement, the so-called localized immersion system and the all-wet immersion system. In a bath type arrangement substantially the whole of the substrate W and optionally part of the substrate table WT is submersed in a bath of liquid.

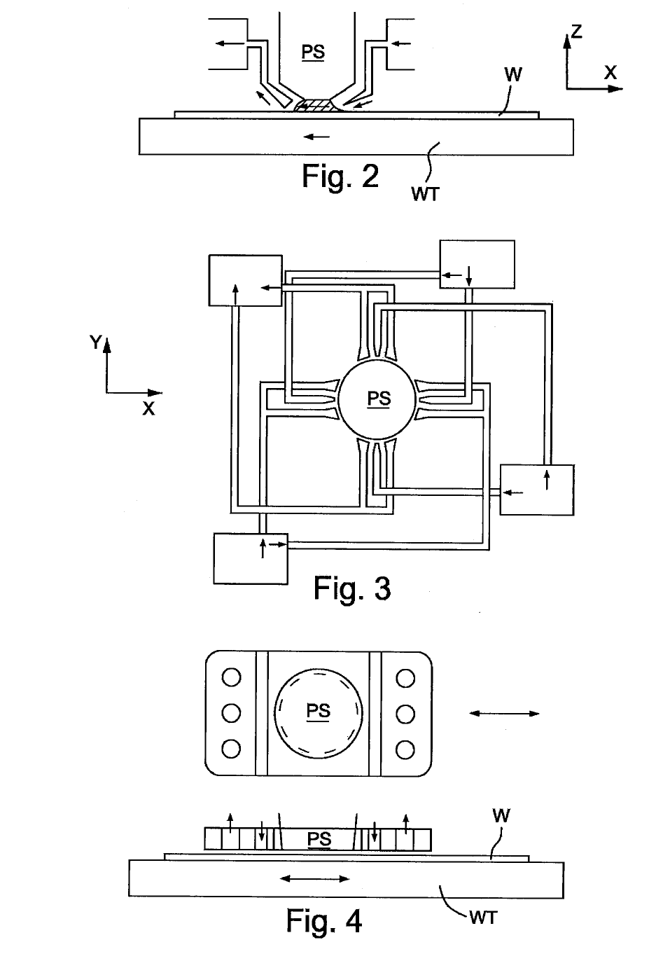

A localized immersion system uses a liquid supply system in which liquid is only provided to a localized area of the substrate. The space filled by liquid is smaller in plan than the top surface of the substrate and the area filled with liquid remains substantially stationary relative to the projection system PS while the substrate W moves underneath that area. FIGS. 2-7 show different supply devices which can be used in such a system. A sealing feature is present to seal liquid to the localized area. One way which has been proposed to arrange for this is disclosed in PCT patent application publication no. WO 99/49504.

In an all wet arrangement the liquid is unconfined. The whole top surface of the substrate and all or part of the substrate table is covered in immersion liquid. The depth of the liquid covering at least the substrate is small. The liquid may be a film, such as a thin film, of liquid on the substrate. Immersion liquid may be supplied to or in the region of a projection system and a facing surface facing the projection system (such a facing surface may be the surface of a substrate and/or a substrate table). Any of the liquid supply devices of FIGS. 2-5 can be used in such a system. However, a sealing feature is not present, not activated, not as efficient as normal or otherwise ineffective to seal liquid to only the localized area.

As illustrated in FIGS. 2 and 3, liquid is supplied by at least one inlet onto the substrate, preferably along the direction of movement of the substrate relative to the final element. Liquid is removed by at least one outlet after having passed under the projection system. As the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. In the illustration of FIG. 2 the liquid is supplied along the direction of movement of the substrate relative to the final element, though this does not need to be the case. Various orientations and numbers of in- and out-lets positioned around the final element are possible; one example is illustrated in FIG. 3 in which four sets of an inlet with an outlet on either side are provided in a regular pattern around the final element. Note that the direction of flow of the liquid is shown by arrows in FIGS. 2 and 3.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets can be arranged in a plate with a hole in its centre and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). Note that the direction of flow of fluid and of the substrate is shown by arrows in FIG. 4.

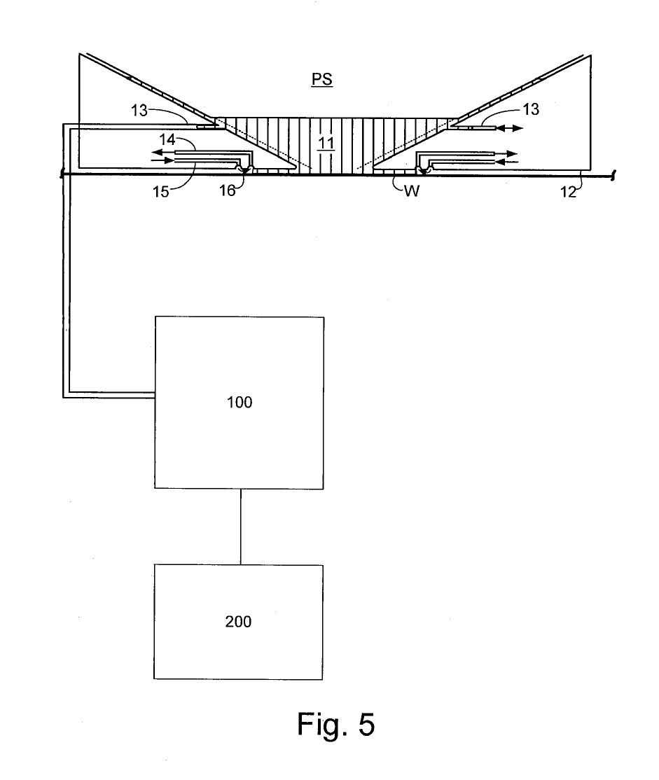

Another arrangement which has been proposed is to provide the liquid supply system with a liquid confinement structure which extends along at least a part of a boundary of the space between the final element of the projection system and the substrate table. Such an arrangement is illustrated in FIG. 5.

FIG. 5 schematically depicts a localized immersion system or fluid handling system with a liquid confinement structure 12. The liquid confinement structure 12 extends along at least a part of a boundary of the space between the final element of the projection system and the substrate table WT or substrate W. (Please note that reference in the following text to surface of the substrate W also refers in addition or in the alternative to a surface of the substrate table, unless expressly stated otherwise.) The liquid confinement structure 12 is substantially stationary relative to the projection system in the XY plane though there may be some relative movement in the Z direction (in the direction of the optical axis). In an embodiment, a seal is formed between the liquid confinement structure 12 and the surface of the substrate W and may be a contactless seal such as a gas seal (such a system with a gas seal is disclosed in European patent application publication no. EP-A-1,420,298) or liquid seal.

The liquid confinement structure 12 at least partly contains liquid in the space 11 between a final element of the projection system PS and the substrate W. A contactless seal 16 to the substrate W may be formed around the image field of the projection system PS so that liquid is confined within the space between the substrate W surface and the final element of the projection system PS. The space 11 is at least partly formed by the liquid confinement structure 12 positioned below and surrounding the final element of the projection system PS. Liquid is brought into the space below the projection system PS and within the liquid confinement structure 12 by liquid inlet 13. The liquid may be removed by liquid outlet 13. The liquid confinement structure 12 may extend a little above the final element of the projection system. The liquid level rises above the final element so that a buffer of liquid is provided. In an embodiment, the liquid confinement structure 12 has an inner periphery that at the upper end closely conforms to the shape of the projection system or the final element thereof and may, e.g., be round. At the bottom, the inner periphery closely conforms to the shape of the image field, e.g., rectangular, though this need not be the case.

The liquid may be contained in the space 11 by a gas seal 16 which, during use, is formed between the bottom of the liquid confinement structure 12 and the surface of the substrate W. The gas seal is formed by gas. The gas in the gas seal is provided under pressure via inlet 15 to the gap between liquid confinement structure 12 and substrate W. The gas is extracted via outlet 14. The overpressure on the gas inlet 15, vacuum level on the outlet 14 and geometry of the gap are arranged so that there is a high-velocity gas flow 16 inwardly that confines the liquid. The force of the gas on the liquid between the liquid confinement structure 12 and the substrate W contains the liquid in a space 11. The inlets/outlets may be annular grooves which surround the space 11. The annular grooves may be continuous or discontinuous. The flow of gas 16 is effective to contain the liquid in the space 11. Such a system is disclosed in United States patent application publication no. US 2004-0207824, which is hereby incorporated by reference in its entirety. In an embodiment, the liquid confinement structure 12 does not have a gas seal.

One or more surfaces of an immersion lithographic apparatus may be deliberately made to have or exceed a certain contact angle, with respect to the immersion liquid. For example, the immersion liquid makes a contact angle, for example a static contact angle, with a surface under certain conditions, for stationary conditions, of generally greater than or equal to 60°, such as greater than or equal to 70°, or greater than or equal to 80°. In an embodiment, one or more surfaces of the lithographic apparatus may be lyophobic with respect to the immersion liquid. That is, for example, the immersion liquid makes a contact angle, for example a static contact angle, with a surface under stationary conditions of generally greater than or equal to 90°, such as greater than or equal to 100°, greater than or equal to 110°, greater than or equal to 120° or greater than or equal to 130°, for example selected from the range of 90-130° or the range of 100-120° at the operating temperature of the immersion liquid in the reservoir, for example, during exposure. With movement substantially parallel to the plane of the surface, the receding contact angle of the liquid relative to the surface is in the range of between 50 and 100°, such as between 50 and 90°, desirably greater than or equal to 60°, in an embodiment greater than or equal to 70°. In an embodiment it may be between 80 and 86°. The advancing contact angle is in the range of 90-130°, desirably less than or equal to 120°. In an embodiment, the advancing angle is between 90 and 100°. All these contact angles are defined at normal operating temperature of the immersion system, for example 22° C.

In immersion lithography, the position of liquid should be controlled. The use of a lyophobic coating (e.g. hydrophobic with respect to water) on one or more certain surfaces can help in controlling the position of liquid, for example a meniscus of a liquid.

The contact angle which the immersion liquid makes with the surface is used to control the immersion liquid. For example, a high contact angle on a top (contact) surface of a substrate table WT is desirable as this can increase the speed at which the substrate table WT may move relative to the liquid confinement structure 12 without liquid loss, for example during swapping of tables under the projection system PS.

Liquid loss is undesirable as this can result in contamination and/or a localized heat load on the substrate table WT and/or the generation of gas bubbles in the immersion liquid, for example. A high speed is desirable to increase throughput through the immersion lithography apparatus.

Other surfaces of the immersion lithographic apparatus, such as a contact surface with which immersion liquid comes into contact, are also desirably lyophobic, in some instances for different reasons, such as for ease of drying.

Examples of other components or parts of components which might be covered with a coating exceeding a certain contact angle, for example a lyophobic coating, include the substrate table, an adherable planar sheet, the final element of the projection system, a part of any fluid handling structure 12 and/or a closing surface. A part of a side surface of the substrate table WT may be covered with a lyophobic coating, the side part forming a channel at the gap between the substrate W and the substrate table WT. The adherable planar sheet (e.g. a sticker) may provide a surface property to a surface and/or bridge a gap adjacent an object, a sensor (e.g. a transmission image sensor (TIS), dose sensor, spot sensor, and/or lens interferometer (e.g. interferometric wave front measurement sensor)). A lyophobic coated surface of the final element of the projection system PS may be, for example, the surface out of the optical path to restrict liquid moving radially outward from the optical axis over the top of the fluid handing structure and thereby confine the immersion liquid to the immersion space. A part of the fluid handling structure 12 may be, for example, the top surface of the fluid handling structure 12 facing the projection system and/or at least part of its undersurface.

A closing surface is a surface of an object which may be placed under the fluid handling structure 12 instead of a substrate, such as a dummy substrate, second table or a bridging element between two tables. A closing surface is a surface used to block an opening of a fluid handling structure during, for example, table swap under the projection system PS replacing, for example, a substrate. The closing surface may be or include a dummy substrate, a bridging element, or a separate table. The tables are exchanged using the dummy substrate to confine the fluid in the space 11 during the exchange. A closing surface as a bridging element (which may be referred to as a swap bridge) may be retractable and may be a part of one of the tables. The bridging element may function as a dummy substrate present in the gap between at least two tables (for example a substrate table and a measurement table or two substrate tables) during, for example, swapping of tables (e.g. two substrate tables or a substrate table for a measurement table) under the projection system PS. The bridging element may be attached to a table, for example, at least the duration during which the bridging element passes underneath the projection system PS. In an embodiment the closing surface may be part of a separate table, such as a measurement table.

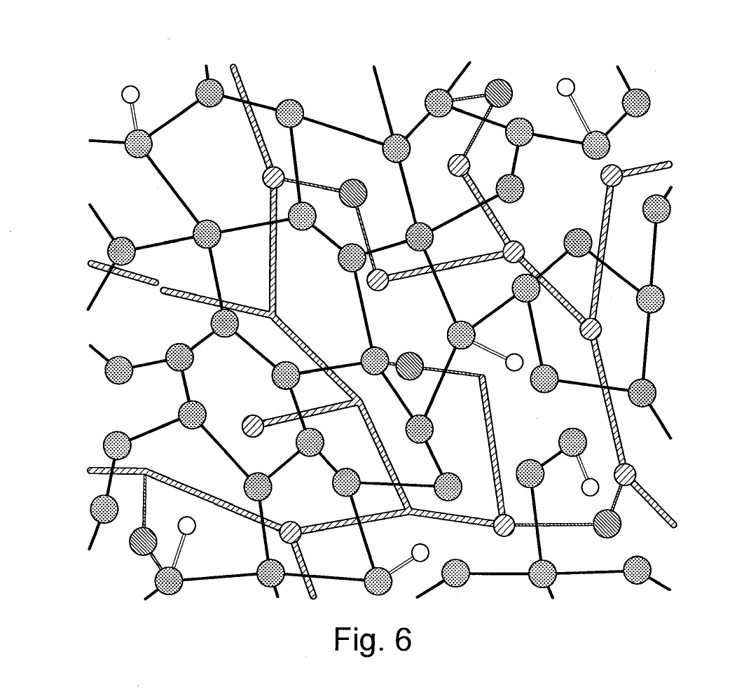

A surface with a contact angle exceeding a certain contact angle, for example a lyophobic surface, may comprise at least one lyophobic group. A lyophobic group is a group which is responsible for the lyophobic nature of the surface. The lyophobic group may be selected from the non-exhaustive list consisting of: methyl, ethyl, CF₃, CF₂ and F. These groups are hydrophobic. Methyl groups are preferred to ethyl groups as they are more lyophobic. The surface may comprise a coating. The surface or coating may, for example, be made of any material based on C and H including, but not limited to polytetrafluoroethylene (PTFE) (available under the trade name Teflon®), fluorinated ethylene propylene (FEP), ethylene tetrafluoroethylene (ETFE), polyvinylidene fluoride (PVDF), perfluoroalkoxy (PFA), polyisobutylene (PIB, butyl rubber), poly(hexafluoropropylene), paraffin, hexatriacontane, poly t-butyl methacrylate (PtBMA), polydimethylsiloxane (PDMS), polypropylene (PP), polychlorotrifluoroethylene (PCTFE), polyethylene (PE), polybutadiene, nylon 10, 10, polytrifluoroethylene, and/or poly n-butyl methacrylate (PnBMA). The surface or coating may, for example, be made of a compound containing Si and O and optionally at least one of C, H and F (for example a material such as disclosed in United States patent application publication nos. US 2009-0206304 and US 2011-0135839) and which is sometimes referred to as Lipocer™. The surface or coating may, for example, be made of a DLN-F. Diamond-Like-Nanocomposite (DLN) coatings are coatings with proven qualities in non-stick applications. They show high hardness and low surface roughness. Combined with their low surface free energy this makes them suitable candidates for UV resistant hydrophobic coating applications. DLN is a carbon and hydrogen based coating with a structure that is a mixture of sp2 (graphite) and sp3 (diamond) bondings, an additional silicon and oxygen network is incorporated therein. In the case of DLN-F, there is also an addition of a Fluorine network (each fluorine atom attached to a carbon atom), as shown in FIG. 6 where the carbon atoms are the large dotted circles, the silicon atoms are the small cross-hatched circles, the oxygen atoms are large cross-hatched circles between the carbon and silicon atoms, and the fluorine atoms are the small unfilled circles attached to carbon atoms. DLN-F coating is an amorphous material, which may be formed by a plasma polymerization at a temperature of about 200° C. and chamber pressure of about 10⁻³ torr in a PECVD reactor. In the experiment of FIG. 10, the coating was applied on a glass plate with a layer thickness of 250 nm.

Many components of an immersion lithographic apparatus have a surface which has a particular contact angle range with respect to the immersion liquid. The surface thus has a surface property with respect to the liquid. Such a surface may be lyophobic or lyophilic, for example hydrophobic or hydrophilic with respect to water. Such a surface may be used to help control the position of liquid, for example to prevent liquid loss. If the position of liquid is not correctly controlled, this may lead to unwanted measurement errors and/or increased defectivity. In an embodiment, a coating may be used to provide the surface property. The surface property, for example a lyophobic coating, may suffer from degradation in the contact angle which immersion liquid makes with the coating during use. Degradation may be due to irradiation from the projection beam and/or exposure to immersion liquid.

If the contact angle which immersion liquid makes with a component surface or a coating providing the component surface (as mentioned herein) is outside a range limit, for example exceeds above or recedes below a certain threshold, action should be taken to reinstate the contact angle; otherwise machine performance may deteriorate. (Reference to a deteriorated coating includes reference to deterioration of a surface property of an uncoated surface unless otherwise stated.) One way of doing this is to replace the component. This is undesirable because of the cost involved in replacing the component and the downtime of the apparatus which results from the need to replace the component. Alternatively or additionally, an adherable planar component, for example a sticker, may be placed over the surface. The sticker has the desired contact angle property with the immersion liquid. This method may be undesirable because it may require the removal of the component from the apparatus for proper application of the sticker, thereby requiring downtime of the apparatus. A sticker has a certain minimum thickness so that applying a sticker can result in a change in the level of the surface. Applying a sticker may undesirably result in a change in the surface topography. Additionally, the application of a sticker may change a mechanical property of the surface to which it is applied and/or an optical property of the surface to which it is applied.

Change in contact angle of a surface may be a result of the presence of immersion liquid, e.g., ultra pure water, on the surface. The contact angle may degrade on irradiation by a beam, such as the projection/patterned beam. Most marked degradation is of a surface which is in contact with immersion liquid and is simultaneously irradiated by the projection beam PB. The projection beam (particularly at 193 nm but also at other wavelengths such as 365, 248, 157 or 126 nm) may cause photoionization of the immersion liquid. The one or more products of photoionization may then react with a lyophobic and/or lyophilic group (hereinafter referred to as an ‘active group’) of the surface (whether the surface is lyophilic or lyophobic) to reduce the contact angle of the surface. For example, reaction of the active group (e.g., a lyophobic group) with a product of photoionization of the immersion liquid may result in changing the character of the group (e.g., a lyophobic group) or loss of the group from the surface. See, e.g., Nobuyuki Ichinose et al. entitled “Excimer Laser-Induced Surface Reaction of Fluoropolymers with Liquid Water” in Macromolecules, 1996, 29(11) of 20 May 1996.

In an embodiment the immersion liquid is supplied with a protection component. The protection component is chosen on the basis that it reacts with one or more of products of photoionization of the immersion liquid. In an embodiment, the protection component reacts with one or more, or all, the products of photoionization of the immersion liquid that affect the contact angle exhibited by a surface, i.e., the lyophobic or lyophilic nature of the surface. In an embodiment the reaction product and the protection component itself have no or limited detrimental effects on the properties of the immersion liquid. Such properties may include substantially constant refractive index, the absence of bubbles and/or inertness with materials used in the lithographic apparatus and with which the immersion liquid comes into contact. In an embodiment the protection component is more reactive with a product of photoionization of the immersion liquid than the product of photoionization has with an active group (for example electron affinity and/or reactivity toward radicals). As a result, the product of photoionization of the immersion liquid reacts with the protection component in preference to the active group. In this way, the active group is protected and the lyophobic or lyophilic character of the surface should last longer, for example the contact angle exhibited by the surface with respect to the immersion liquid should be maintained (e.g., should not reduce).

In an embodiment, the protection component is present in an amount less than or equal to 5 ppm, or less than or equal to 1 ppm or less than or equal to 0.5 ppm. In an embodiment, the protection component is present in an amount of greater than or equal to 0.1 ppm or greater than or equal to 0.2 ppm in the immersion liquid. At this level of concentration the protection component will be effective in its aim of protecting the active group the surface (whether lyophobic or lyophilic), for example to maintain the contact angle of the surface. However, the level of concentration is in a quantity low enough not to affect the imaging properties of the immersion liquid. The desired amount of protection component may vary dependent upon the species of protection component.

In the case of the immersion liquid being ultra-pure water, a level of the protection component of at least 0.1 ppm is relatively high in comparison to the allowable concentration of other components in the ultra-pure water. A definition of ultra-pure water (UPW) is available from www.semi.org, for example specification SEMI F063 UPW which is hereby incorporated by reference in its entirety. This specification, for example, requires dissolved oxygen to be present at a level of less than 10 ppb, dissolved nitrogen to be at a level of 8-18 ppm, for silica to be at a level of less than 0.5 ppb and in its form dissolved as SiO₂ at a level of less than 0.5 ppb. Ions and metals are generally required to be present at less than 50 ppt, and in some cases, desirably for metals, even lower. For the case of the immersion liquid in the form of ultra-pure water, such as defined in SEMI F063 UPW, the immersion liquid is ultra pure water as so defined apart from the level of the protection component. Therefore, for such water, a level of the protection component of at least 0.1 ppm is actually quite high.

In one embodiment the immersion liquid comprises water as a solvent. Any ions or metals in the immersion liquid other than the single component solvent and the protection component are present in an amount of less than 100 ppt. In an embodiment any silica in the immersion liquid is present in an amount of less than 1 ppb. In an embodiment any nitrogen in the immersion liquid is present in an amount of less than 30 ppm. In an embodiment any total organic carbon (TOC) in the immersion liquid is present in an amount of less than 10 ppb.

Although an embodiment of the invention is described mostly with reference to the immersion liquid comprising water as a solvent, an embodiment of the present invention is applicable to other immersion liquids, desirably those which denature upon photoionization by a wavelength of radiation of the immersion lithographic apparatus.

The protection component is any component which is more reactive with one or more products of photoionization of the immersion liquid than an active group of a surface which has or exceeds a certain contact angle with respect to the immersion liquid. In one embodiment the protection component comprises oxygen. In one embodiment the protection component comprises an antioxidant. Some examples of antioxidants are ascorbic acid, resveratrol, ethoxyquin and polyphenols, although one or more of these may not be appropriate for use in a lithographic apparatus in certain circumstances. Ascorbic acid and resveratrol are water soluble. Ethoxyquin is a liquid antioxidant with a moderate solubility/ miscibility with water. In an embodiment, the antioxidant is not solid and/or highly soluble in liquid.

In the case of the immersion liquid comprising water as a solvent, photoionization can be expected to lead to disassociation of water into an H⁺ ion, a ⁻OH ion and a hydrated electron e_{aq}⁻, as is stated in equation (1) below. For the case of a fluoropolymer (for example PTFE) the reaction pathway of the hydrated electron with the fluoropolymer is illustrated in equations (2)-(8) below, in accordance with the above mentioned article by Nobuyuki Ichinose et al.

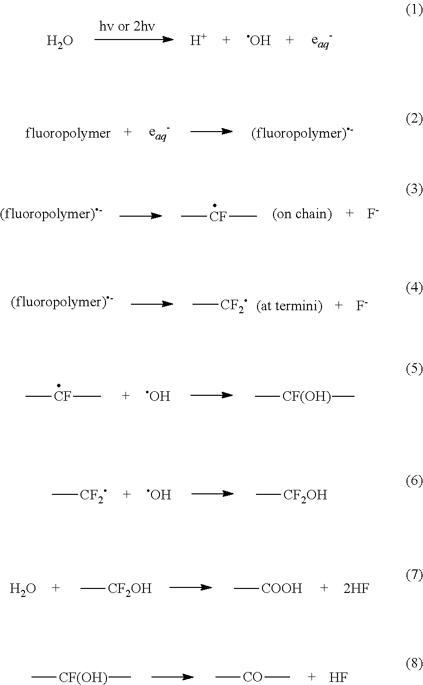

Therefore the protection component should be more reactive with at least one product of photoionization of the immersion liquid than the active group. In an embodiment the protection component is more reactive with a hydrated electron than the active group. In an embodiment the protection component acts as a scavenger of the hydrated electrons and the radicals. For example, reaction of oxygen with the H⁺ ion may result in the formation of water and/or hydrogen peroxide.

In the case of the protection component being a gas dissolved in the immersion liquid, an upper limit of 1 ppm is suitable. This is because above the upper limit of 1 ppm the chance of formation of bubbles of the protection component in the immersion liquid may be too high. The formation of bubbles (for example spontaneously) in the immersion liquid is undesirable and this can lead to imaging errors. In such an imaging error, a bubble may be in the path of the projection beam distorting at least part of the image imaged onto the substrate.

In the example of the protection component being oxygen, at one atmosphere and 20° C. oxygen saturates at a level of 5 ppm in water. Therefore a maximum level of 1 ppm is a saturation level of only 20% at typical operating conditions of a lithographic apparatus. This level is a desirably safe level with regard to the chance of spontaneous bubble formation in the immersion liquid by which the protection component comes out of solution in the immersion liquid.

In an embodiment the liquid confinement structure 12 is provided with immersion liquid by an immersion liquid supply system 100. The immersion liquid supply system 100 is adapted to provide immersion liquid comprising the protection component to the liquid confinement structure 12.

A controller 200 is provided to control the immersion liquid supply system 100. The controller 200 controls the immersion liquid supply system 100 to provide immersion liquid with the correct composition, desirably with the correct amount of protection component present in the immersion liquid.

In an embodiment the controller 200 may control the immersion liquid supply system 100 (for example by providing a signal to the immersion liquid supply system 100) to vary the amount of protection component present in the immersion liquid. In an embodiment the concentration of the protection component in the immersion liquid is sensed and the signal provided by the controller to the immersion liquid supply system 100 is adjusted accordingly such that the desired concentration of protection component is achieved. For example, the controller 200 may include a sensor, such as an optical sensor, to determine the concentration of the component in the immersion liquid. Such a sensor may be located in the immersion liquid supply system 100 and may measure liquid in the space 11, liquid being supplied to space 11 or liquid being removed from the space 11.

In an embodiment the controller 200 may control the immersion liquid supply system 100 to provide immersion liquid with the protection component present in a first desired range (for example between 0.1-5 ppm, for between 0.1-1 ppm) during certain operations of the immersion lithographic apparatus. For example, the protection component may be provided in the first desired range during most of the operation of the lithographic apparatus including, but not limited to, one or more operations of imaging, alignment, measurement, and/or a movement of the substrate table WT (or a measurement table) under the protection system PS.

In an embodiment, in certain circumstances the controller 200 may control the immersion liquid supply system 100 to increase the amount of protection component in the immersion liquid. In an example, the controller 200 instructs the immersion liquid supply system 100 to increase the amount of protection component to a second desired level (e.g. equal to or greater than 1 ppm, or equal to or greater than 2 ppm, or equal to or greater than 4 ppm). In an embodiment the controller 200 controls the immersion liquid supply system 100 to increase the amount of protection component during a cleaning operation. As is disclosed in United States patent application publication nos. US 2008/0271747, US 2009/0091716 and US 2009/0027635, the entire contents of each is incorporated hereby by reference, it may be desirable to increase the oxygen content of immersion liquid or of a cleaning liquid during cleaning of components of a lithographic apparatus. However increasing the content of oxygen in the immersion liquid during normal operation is undesirable, as described above, because of the increased risk of the formation of a bubble in the immersion liquid.

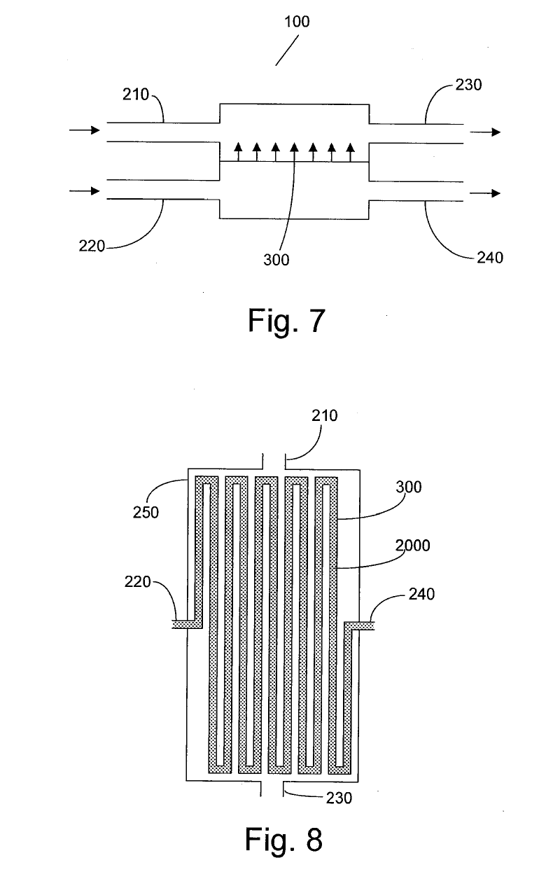

The liquid supply system 100 may introduce the protection component into the immersion liquid (for example a source of ultra-pure water) using a membrane 300 as illustrated in FIG. 7. The immersion liquid supply system 100 comprises a membrane 300 which is arranged such that immersion fluid flows past the membrane 300 on one side and the protection component is present on the other side of the membrane 300.

The membrane 300 behaves as if non-porous to the immersion liquid (usually (ultra pure) water) and porous to the protection component (e.g. a gas, such as oxygen). It should be possible to pressurize the liquid side of the membrane 300 (though this is not necessary) and no liquid should pass through the membrane 300. One can also pressurize the gas side (at least using air or its components like nitrogen, oxygen etc.). Gas dissolves into the liquid from the gas side of the membrane 300 but no bubbles form in the liquid. Thus, the membrane 300 can be seen as porous to gas but not liquid.

In an embodiment the membrane 300 is fibrous and hydrophobic such as a polypropylene hollow fiber. This allows gas to pass through it in one direction (due to the difference in concentration in the gas on the one side of the membrane 300 and concentration of gas on the other side of the membrane where immersion liquid is present). However, it prevents the immersion liquid from seeping through the membrane to the side with the gas.

A first conduit 210 guides immersion liquid to which a protection component is to be added to one side of the membrane 300 and a second conduit 220 guides the protection component to the other side of the membrane 300. As the protection component is present on one side of the membrane 300 and the liquid on the other side of the membrane 300 gas will pass through the membrane 300 and dissolve in the liquid. Desirably a flow of protection component is provided past the membrane 300 so that a third conduit 240 is provided to guide the protection component away from the membrane 300. A fourth conduit 230 is provided to guide liquid away from the other side of the membrane 300.

It is desirable to maximize the surface area of membrane. A desirable embodiment is where the membrane is a hollow fiber with the liquid passing through the inside of the hollow fiber and the gas passing over the outside of the hollow fiber (though vice versa could be true also). One such embodiment is illustrated in FIG. 8 in which the liquid is provided through hollow fiber 2000 which is comprised of the membrane 300. Only one fiber is illustrated in FIG. 8. The second conduit 220 could be connected to several fibers in parallel.

In the embodiment of FIG. 7 the gas enters a housing 250 which surrounds the hollow fiber 2000 and is passed over the fiber after being guided by conduit 210 into the housing. In an embodiment the gas is guided out of the housing by third conduit 230.

In order to provide the flow of gas and flow of liquid, a liquid provider and gas provider are provided. These could take the form, for example, of a pump providing the liquid and a compressed gas source.

A similar principle can be used in the case where the protection component is non-gaseous and is in liquid form, the driving force across the membrane 300 being osmotic pressure to equal out concentrations on either side of the membrane 300.

In an embodiment the immersion liquid supply system 100 comprises a degassing unit. The degassing unit is used to remove gas from solution in the immersion liquid. In the case that the immersion liquid before it enters the degassing unit comprises the protection component in an amount greater than the desired amount, the degassing unit can be controlled to degas the immersion liquid such that the protection component is at the desired concentration. This can be under control of the control unit 200 (including, optionally, its sensor). In this embodiment, compared to the prior art, the degassing unit (for example a degassing unit such as that available from Membrane GmbH of Wuppertal, Germany) would not be operated to ensure that the immersion liquid meets the definition for ultra pure water (SEMI F063 UPW). Instead the degassing unit would be operated to ensure that protection component remained at a higher level in the immersion liquid, following degassing.

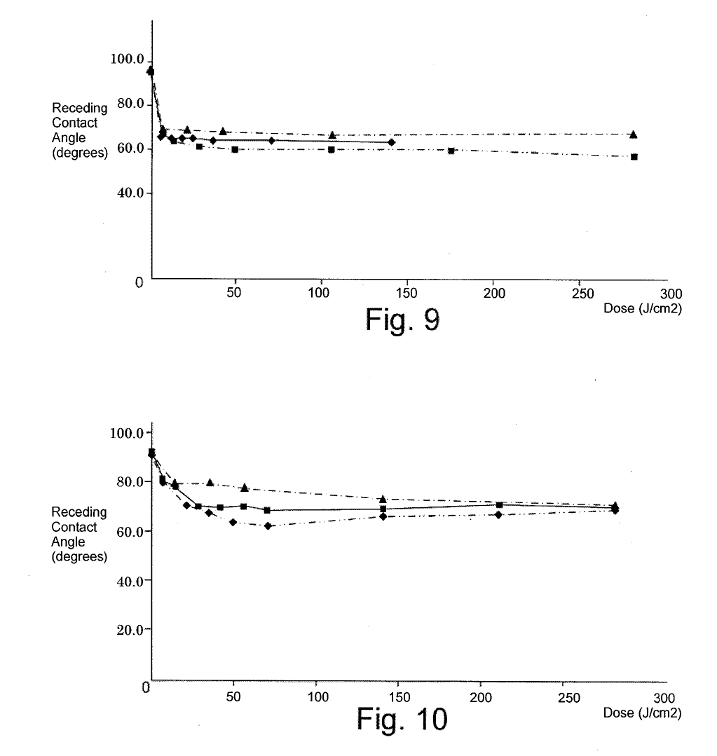

Experiments have been carried out on Lipocer (TM) and DLN-F coating under conditions simulating conditions in an immersion lithographic apparatus. Example coatings were irradiated with 193 nm laser irradiation and had a flow rate of water over the coating of 1 L/min with a depth of 20 mm of water over the coating. The laser used had a design power of 10W, a maximum repetition rate of 2000 Hz, a normal pulse energy of 5000 mJ and a pulse length of about 25 ms. The average energy was 0.7 mJ/cm²/pulse. The water had a temperature of 22.2° C. The concentration of oxygen in the water was varied between 0.2 ppm and 3.0 ppm. The results of the experiments are plotted in FIG. 9 in which the receding contact angle is plotted on the y-axis in increments of 20 degrees and the dose in mJ/cm² along the x-axis in increments of 50 mJ/cm² and in FIG. 10 in which the receding contact angle is plotted on the y-axis in increments of 10 degrees and the dose in mJ/cm² along the x-axis in increments of 50 mJ/cm².

FIG. 9 shows the change in receding contact angle for Lipocer™ over a period of exposure to about 250 to 300 J/cm², which equates to about 5 days of exposure in a lithographic apparatus. The results for an oxygen concentration in the water of 0.2 ppm are shown in squares, for 1.0 ppm in diamonds and for 3.0 ppm in triangles. As can be seen, after about 5 days of exposure the difference in contact angle of the coating for a concentration of oxygen of 0.2 ppm to a concentration of 3.0 ppm is about 10°. This shows that the higher the oxygen concentration, the greater the receding contact angle. The trend is clear from FIG. 9 and it shows that including dissolved oxygen in immersion liquid (e.g. water) during DUV exposure of Lipocer™ and contact with immersion liquid reduces the decrease in receding contact angle over time. The experimental results show that the incorporation of a protection component, in this example oxygen, is beneficial in terms of reducing the reduction in receding contact angle with time.

FIG. 10 shows the results for DLN-F under the substantially same conditions as the results of FIG. 9. Again, a higher concentration of oxygen in the immersion liquid results in a lower reduction in receding contact angle.

Although the concentrations of dissolved oxygen used in the experiments of FIGS. 9 and 10 may be too high (due to the risk of bubble formation), the results do show the benefit of having a protection component (in particular dissolved oxygen) in the immersion liquid.

In an embodiment, there is provided an immersion lithographic apparatus comprising: a lyophobic surface comprising at least one lyophobic group which, during use, comes into contact with immersion liquid; and an immersion liquid supply system configured to provide immersion liquid comprising a protection component which is more reactive with a product of photoionization of the immersion liquid than at least one lyophobic group of the lyophobic surface, the protection component being present in an amount of at least 0.1 ppm.

In an embodiment, the protection component is present in an amount of at most 5 ppm. In an embodiment, the protection component is present in an amount of at least 0.2 or at most 1 ppm. In an embodiment, the protection component is present in an amount of between 0.2 and 0.5 ppm. In an embodiment, the protection component is a gas which is dissolved in the immersion liquid. In an embodiment, the protection component comprises a substance selected from the group: oxygen, antioxidants. In an embodiment, the lyophobic group is selected from the group consisting of: methyl, ethyl, CF₃, CF₂ and/or F. In an embodiment, the lyophobic surface comprises a coating. In an embodiment, the lyophobic surface comprises one or more compounds selected from the group: a compound containing C and H; DLN-F; PTFE; FEP; ETFE; PVDF; PFA; polyisobutylene (PIB, butyl rubber); poly(hexafluoropropylene); paraffin; hexatriacontane; poly t-butyl methacrylate (PtBMA); polydimethylsiloxane (PDMS); polypropylene (PP); polychlorotrifluoroethylene (PCTFE); polyethylene (PE); polybutadiene; nylon 10, 10; polytrifluoroethylene; poly n-butyl methacrylate (PnBMA); and/or a compound containing Si and O and optionally at least one of C, H and F. In an embodiment, the immersion liquid comprises water as a solvent. In an embodiment, any ions or metals in the immersion liquid other than a single component solvent and the protection component are present in an amount of less than 100 ppt. In an embodiment, any silica in the immersion liquid is present in an amount of less than 1 ppb. In an embodiment, any nitrogen in the immersion liquid is present in an amount of less than 30 ppm. In an embodiment, any TOC in the immersion liquid is present in an amount of less than 10 ppb. In an embodiment, the immersion liquid supply system comprises a membrane arranged such that immersion fluid flows past the membrane on one side and the protection component is present on the other side of the membrane. In an embodiment, the immersion lithographic apparatus further comprises a controller adapted to control the immersion liquid supply system to supply immersion liquid with the protection component present in a desired amount during at least one operation of the immersion lithographic apparatus selected from the group consisting of: a) an imaging operation, b) an alignment operation, c) a measurement operation, d) an operation involving a movement of a table under a projection system. In an embodiment, the controller is adapted to control the immersion liquid supply system to increase the amount of protection component in the immersion liquid during a cleaning operation. In an embodiment, the immersion lithographic apparatus further comprises a substrate table configured to support a substrate and comprising a contact surface with which, in use, immersion liquid comes into contact. In an embodiment, the immersion lithographic apparatus further comprises a projection system configured to support a substrate and comprising a contact surface with which, in use, immersion liquid comes into contact. In an embodiment, the immersion lithographic apparatus further comprises a liquid confinement structure for supplying a liquid to a space beneath a projection system and comprising a contact surface with which, in use, immersion liquid comes into contact. In an embodiment, the lyophobic surface is the contact surface.

In an embodiment, there is provided an immersion lithographic apparatus comprising: a lyophilic surface comprising at least one lyophilic group which, during use, comes into contact with immersion liquid; and an immersion liquid supply system configured to provide immersion liquid comprising a protection component which is more reactive with a product of photoionization of the immersion liquid than at least one lyophilic group of the lyophilic surface, the protection component being present in an amount of at least 0.1 ppm.

In an embodiment, there is provided an immersion lithographic apparatus comprising: an active surface comprising at least one active group which, during use, comes into contact with immersion liquid, the surface having or exceeding a certain contact angle with respect to the immersion liquid; and an immersion liquid supply system configured to provide immersion liquid comprising a protection component which is more reactive with a product of photoionization of the immersion liquid than at least one active group of the surface, the protection component being present in an amount of at least 0.1 ppm.

In any embodiment the protection component may be present in an amount of at most 5 ppm, and/or the protection component may be present in an amount of at most 1 ppm, and/or the protection component may be present in an amount of between 0.2 and 0.5 ppm, and/or the protection component may be a gas which is dissolved in the immersion liquid, and/or the protection component may comprise one or more substances selected from the group: oxygen and/or an antioxidant, and/or the immersion liquid may comprise water as a solvent, and/or any ions or metals in the immersion liquid other than a single component solvent and the protection component may be present in an amount of less than 100 ppt, and/or any silica in the immersion liquid may be present in an amount of less than 1 ppb, and/or any nitrogen in the immersion liquid may be present in an amount of less than 30 ppm, and/or any total organic carbon in the immersion liquid may be present in an amount of less than 10 ppb, and/or the immersion liquid supply system may comprise a membrane arranged such that immersion fluid flows past the membrane on one side and the protection component may be present on the other side of the membrane, and/or the immersion lithographic apparatus may further comprise a controller configured to control the immersion liquid supply system to supply immersion liquid with the protection component present in a desired amount during at least one operation of the immersion lithographic apparatus selected from the group consisting of: a) an imaging operation, b) an alignment operation, c) a measurement operation, and/or d) an operation involving a movement of a table under a projection system, and/or the controller may be configured to control the immersion liquid supply system to increase the amount of protection component in the immersion liquid during a cleaning operation, and/or the immersion lithographic apparatus may further comprise a substrate table configured to support a substrate and comprising a contact surface with which, in use, immersion liquid comes into contact, and/or the immersion lithographic apparatus may further comprise a projection system configured to support a substrate and comprising a contact surface with which, in use, immersion liquid comes into contact, and/or the immersion lithographic apparatus may further comprise a liquid confinement structure to supply a liquid to a space beneath a projection system and comprising a contact surface with which, in use, immersion liquid comes into contact, preferably wherein the lyophobic, lyophilic or active surface is the contact surface.

In an embodiment, there is provided a device manufacturing method comprising: providing a liquid on a lyophobic surface comprising at least one lyophobic group; wherein the liquid comprises a protective component which is more reactive with a product of photoionization of the immersion liquid than at least one lyophobic group of the lyophobic surface, the protection component being present in an amount of at least 0.1 ppm.

In an embodiment, there is provided an immersion lithographic apparatus comprising: a lyophobic surface comprising at least one lyophobic group which, during use, comes into contact with immersion liquid; an immersion liquid supply system adapted to provide immersion liquid comprising a protection component which is more reactive with a product of photoionization of the immersion liquid than at least one the lyophobic group of the lyophobic surface, the protection component being an antioxidant.

As will be appreciated, any of the above described features can be used with any other feature and it is not only those combinations explicitly described which are covered in this application.

Although specific reference may be made in this text to the use of lithographic apparatus in the manufacture of ICs, it should be understood that the lithographic apparatus described herein may have other applications in manufacturing components with, for example, microscale, or even nanoscale, features, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm). The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

Any controllers described herein may each or in combination be operable when the one or more computer programs are read by one or more computer processors located within at least one component of the lithographic apparatus. The controllers may each or in combination have any suitable configuration for receiving, processing, and sending signals. One or more processors are configured to communicate with the at least one of the controllers. For example, each controller may include one or more processors for executing the computer programs that include machine-readable instructions for the methods described above. The controllers may include data storage medium for storing such computer programs, and/or hardware to receive such medium. So the controller(s) may operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more fluid openings including one or more liquid openings, one or more gas openings or one or more openings for two phase flow. The openings may each be an inlet into the immersion space (or an outlet from a fluid handling structure) or an outlet out of the immersion space (or an inlet into the fluid handling structure). In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. An immersion lithographic apparatus comprising:
a lyophobic surface comprising at least one lyophobic group which, during use, comes into contact with immersion liquid; and
an immersion liquid supply system configured to provide immersion liquid comprising a protection component which is more reactive with a product of photoionization of the immersion liquid than at least one lyophobic group of the lyophobic surface, the protection component being present in an amount of at least 0.1 ppm.

2. The immersion lithographic apparatus of claim 1, wherein the lyophobic group is one or more selected from the group consisting of: methyl, ethyl, CF₃, CF₂ and/or F.

3. The immersion lithographic apparatus of claim 1, wherein the lyophobic surface comprises a coating.

4. The immersion lithographic apparatus of claim 1, wherein the lyophobic surface comprises one or more compounds selected from the group: a compound containing C and H; DLN-F; PTFE; FEP; ETFE; PVDF; PFA; polyisobutylene (PIB, butyl rubber);
poly(hexafluoropropylene); paraffin; hexatriacontane; poly t-butyl methacrylate;
polydimethylsiloxane; polypropylene; polychlorotrifluoroethylene; polyethylene;
polybutadiene; nylon 10, 10; polytrifluoroethylene; poly n-butyl methacrylate; and/or a compound containing Si and O and optionally at least one of C, H and F.

5. The immersion lithographic apparatus of claim 1, wherein the protection component is present in an amount of at most 5 ppm.

6. The immersion lithographic apparatus of claim 1, wherein the protection component is a gas which is dissolved in the immersion liquid.

7. The immersion lithographic apparatus of claim 1, wherein the protection component comprises one or more substances selected from the group: oxygen and/or an antioxidant.

8. The immersion lithographic apparatus of claim 1, wherein the immersion liquid comprises water as a solvent.

9. The immersion lithographic apparatus of claim 1, wherein any ions or metals in the immersion liquid other than a single component solvent and the protection component are present in an amount of less than 100 ppt.

10. The immersion lithographic apparatus of claim 1, wherein any silica in the immersion liquid is present in an amount of less than 1 ppb.

11. The immersion lithographic apparatus of claim 1, wherein any nitrogen in the immersion liquid is present in an amount of less than 30 ppm.

12. The immersion lithographic apparatus of claim 1, wherein any total organic carbon in the immersion liquid is present in an amount of less than 10 ppb.

13. The immersion lithographic apparatus of claim 1, wherein the immersion liquid supply system comprises a membrane arranged such that immersion fluid flows past the membrane on one side and the protection component is present on the other side of the membrane.

14. The immersion lithographic apparatus of claim 1, further comprising a controller configured to control the immersion liquid supply system to supply immersion liquid with the protection component present in a desired amount during at least one operation of the immersion lithographic apparatus selected from the group consisting of:
a) an imaging operation,
b) an alignment operation,
c) a measurement operation, and/or
d) an operation involving a movement of a table under a projection system.

15. The immersion lithographic apparatus of claim 1, further comprising a substrate table configured to support a substrate and comprising a contact surface with which, in use, immersion liquid comes into contact.

16. The immersion lithographic apparatus of claim 15, wherein the lyophobic, lyophilic or active surface is the contact surface.

17. An immersion lithographic apparatus comprising:
a lyophilic surface comprising at least one lyophilic group which, during use, comes into contact with immersion liquid; and
an immersion liquid supply system configured to provide immersion liquid comprising a protection component which is more reactive with a product of photoionization of the immersion liquid than at least one lyophilic group of the lyophilic surface, the protection component being present in an amount of at least 0.1 ppm.

18. An immersion lithographic apparatus comprising:
an active surface comprising at least one active group which, during use, comes into contact with immersion liquid, the surface having or exceeding a certain contact angle with respect to the immersion liquid; and
an immersion liquid supply system configured to provide immersion liquid comprising a protection component which is more reactive with a product of photoionization of the immersion liquid than at least one active group of the surface, the protection component being present in an amount of at least 0.1 ppm.

19. A device manufacturing method comprising:
providing a liquid on a lyophobic surface comprising at least one lyophobic group;
wherein the liquid comprises a protective component which is more reactive with a product of photoionization of the immersion liquid than at least one lyophobic group of the lyophobic surface, the protection component being present in an amount of at least 0.1 ppm.

20. An immersion lithographic apparatus comprising:
a lyophobic surface comprising at least one lyophobic group which, during use, comes into contact with immersion liquid; and
an immersion liquid supply system configured to provide immersion liquid comprising a protection component which is more reactive with a product of photoionization of the immersion liquid than at least one lyophobic group of the lyophobic surface, the protection component being an antioxidant.
